(19) United States
(12) Patent Application Publication
(10) Pub. No.: US 2015/0038886 A1
(43) Pub. Date: Feb. 5, 2015

(54) DELIVERY OF AUDIO AND TACTILE STIMULATION THERAPY FOR ANIMALS AND HUMANS

(71) Applicant: Nuro Health, LLC, Wayzata, MN (US)

(72) Inventor: Buddy Snow, Wayzata, MN (US)

(21) Appl. No.: 14/378,200

(22) PCT Filed: Feb. 11, 2013
(86) PCT No.: PCT/US2013/025571

§ 371 Date: Aug. 12, 2014

Related U.S. Application Data
(60) Provisional application No. 61/597,960, filed on Feb. 13, 2012.

(51) Int. Cl. A61H 23/00

(52) U.S. Cl. CPC A61H 23/00
USPC 601/46

(57) ABSTRACT

A system for providing a therapeutic treatment to a mammal for a selected mammalian condition includes a wearable member configured for use about an upper torso of a mammal and an energy module configured to generate energy waves in an energy range particularly configured to provide a stimulation that is therapeutically effective treatment for the selected mammalian condition. The energy module is adapted to be supported by the wearable member about the upper torso of the mammal. The wearable member also includes a therapy delivery portion configured to position the energy module at a treatment site about the upper torso. The underlying idea of the teachings herein is to deliver non-invasive, non-electrical-inducing therapies and energies such as vibroacoustic, physioacoustic, kinesitherapy and phototherapy, through wearable and non-wearable apparatuses to animals and humans for therapeutic treatment.

### CLAIM OF PRIORITY AND CROSS REFERENCE TO RELATED APPLICATION

This application claims priority of U.S. Provisional Patent Application Ser. No. 61/597,960, filed Feb. 13, 2012, entitled, “Method and Apparatus to Deliver External Stimulation to Humans and Animals for Therapeutic Effects”, the teachings of which are incorporated herein by reference in its entirety. This application is also related to U.S. Patent Publication No. 2012/0253236 to Snow et al and published on Oct. 4, 2012, which is also incorporated herein by reference in its entirety.

### FIELD AND BACKGROUND OF THE INVENTION

The invention is in the field of external therapeutic stimulation and delivery of therapeutic energy to animals or humans.

Today it is well known to provide humans and animals with vibrational therapy through massage chairs, hand massagers, whole body vibration plates, handheld lasers or similar apparatuses that are applied to different parts of the body, sometimes with or without heat. These devices have served to relax the individual by stimulating the nervous system and promoting blood flow and increased oxygen to a particular part of the body to help with conditions and areas such as anxiety, post-operative healing, athletic and general performance, pain, aging, injuries, obesity, and general health. It would be desirable to provide similar therapy options to pets, humans and animals that are convenient and easy to use on a frequent basis, as the brain, nervous system, and body are in a constant state of change and all benefit from new stimulation.

### SUMMARY OF THE INVENTION

Vibroacoustic therapy, physioacoustic therapy, along with kinesitherapy and phototherapy, are non-invasive treatment options that have been shown to benefit humans and animals by stimulating the body in various ways. The many benefits include but are not limited to: stress reduction, increased speed to healing, decreases in pain, improve flexibility and other musculoskeletal benefits, increases in blood circulation, improved spine and brain messaging, improved focus and performance, and many others. Transcutaneous electrical nerve stimulation, implantable neurostimulation and similar treatment modalities introduce an electrical signal into the body to deliver therapeutic benefits. The various embodiments described herein seek to improve upon these by providing non-invasive, non-electrical therapeutic systems that deliver the benefits in more user-friendly apparatuses and methods.

The various embodiments disclosed herein are in the field of external stimulation and/or delivery of energy for therapeutic or medical purposes in various delivery mechanisms. More specifically, methods of focused delivery of non-electrical therapeutic energy via vibration, tones, audio, light or other similar energy sources, through wearable and non-wearable members such as collars, harness, halters, clips, belts, beds, pillows, plates, toys, stuffed animals, stand alone systems and attachments, or similar products, sometimes using embedded leads, conductors or other similar materials or methods are disclosed herein. The methods can be administered or delivered in the form of devices, systems or other products for animals or humans. Additionally, other example embodiments disclosed herein utilize wireless, remote and direct communication technology to interact with and control the device placed on or around the mammalian recipients.

In one example embodiment, by delivering therapeutic energy, specifically tones, light and mechanical vibration to the upper torso region, the recipient receives benefit into the brain and cerebellum through ocular, vestibular and peripheral sensory systems. When tonal vibration is received into the ears, the vestibular cochlear nerve activates neurons that send electrical messages to specific end organs to create outcomes such as improved blood flow, which can increase oxygen levels, reduce inflammation and reduce recovery time from injuries. Similarly, when mechanical vibration is generated by an energy source and placed on a mammal, peripheral sensory nerves are activated. These nerves send signals to the receptor areas of the brain to create outcomes such as increased strength to support structures within the body.

In one example embodiment, a system for providing a therapeutic treatment to a mammal for a selected mammalian condition includes a wearable member configured for use about an upper torso of a mammal. An energy module is included that is configured to generate energy waves in an energy range particularly configured to provide a stimulation that is therapeutically effective treatment for the selected mammalian condition. The energy module is adapted to be supported by the wearable member about the upper torso of the mammal. The wearable member also includes a therapy delivery portion configured to position the energy module at a treatment site about the upper torso. The underlying concept of the teachings is to deliver known non-invasive, non-electrical-inducing therapies and energies such as vibroacoustic, physioacoustic, kinesitherapy and phototherapy, through wearable and non-wearable apparatuses to animals and humans.

In another example embodiment, an apparatus for delivering therapeutic energy to at least a portion of a mammal for a selected mammalian condition comprises a therapy output device adapted to generate energy waves in an energy range configured to provide a therapeutic effect on a mammal. The apparatus further includes means for controlling the therapy output device with the controlling means including an amplifier, memory, and an audio file playing module. The apparatus further includes a power supply means operationally coupled to controlling means and to the therapy output device and a housing configured to enclose the therapy output device, controlling means and power supply means therein.

In yet another example embodiment, a system for providing a therapeutic treatment to a mammal for a selected mammalian condition comprises an energy module adapted to generate energy waves in an energy range configured to provide a therapeutic effect on a mammal. The system also includes means for delivering the energy waves from the energy module to a treatment site, the energy delivering means being coupled to the energy module, wherein the energy delivering means is configured to direct the energy waves proximate to the treatment site of the mammal.

In various example embodiments, the wearable devices are made from or include materials that help to transfer the therapeutic energy throughout the collar and are made from materials that are stretchable, lightweight and adjustable so that apparatus can be secured tightly to an animal and not be constrictive. Such devices have additional components, channels, or other elements to monitor, interact with, direct, control, or similarly embedded elements. In a related example embodiment, an apparatus such as a pad or plate is provided that includes a delivery of therapeutic energy. Such an apparatus may be constructed of pliable or rigid materials and it can be attached to crates, kennels, or similar to deliver therapeutic energy to animals. In yet another related embodiment, there is disclosed a method of delivering therapeutic energy as described herein that can be attached to chairs, beds, or similar items. In yet another embodiment, a device is provided that has flexible arms to grip the neck and locates the therapy output device at the upper torso or at the neck or spine area. Such an apparatus may also have foldable arms.

### BRIEF DESCRIPTION OF THE DRAWINGS

FIG. 1 shows a wearable collar or member that is placed around the neck of a mammal with a pouch or pocket to hold, or a base plate to attach, a therapeutic delivery device.

FIG. 2 shows a harness that is placed on an animal such as a dog or cat, with a pouch or pocket to hold, or a base plate to attach, a therapeutic delivery device on top of a neck or along a spine of the animal.

FIG. 3 shows a collar that is placed around a neck of an animal with a pouch or pocket to hold, or a base plate, to attach a therapeutic delivery device on the top of the neck or along the spine of the animal.

FIG. 3A shows a wearable member secured around an upper torso of an animal or, attaches to an existing collar.

FIGS. 4A-4C illustrates a halter or wearable member that is placed around the neck and over and around the ears of an animal such as a horse or cow.

FIGS. 5A-5B shows a wearable device that is placed on or around the neck of a human and incorporates a therapeutic delivery method.

FIG. 6 illustrates pillows that include a pouch or pocket to hold a therapeutic delivery device.

FIG. 7 illustrates clothing that can be worn by animals or humans that include a pouch or pocket to hold, or a base plate, to attach a therapeutic delivery device.

FIGS. 8A and 8B illustrate a therapeutic delivery device that is attached to or placed in the pouch, pocket, or base plate of the various Figures listed herein. FIGS. 8C and 8D detail a charging stand that can be used with the device described in 8A.

FIG. 9 illustrates an elongated therapeutic delivery device that distributes the internal components to make a unit longer and with a less height form factor.

FIG. 10 illustrates a non-wearable therapeutic delivery device that delivers low frequency tones, audio and resulting vibrations out of the device.

FIG. 11 is another embodiment of a vibration speaker delivery system.

FIG. 12 illustrates a delivery mechanism where the Treatment system is enclosed and attached to a surface to help deliver the therapy over a longer distance.

FIG. 13 illustrates the Treatment system to be included inside the product for a flat surface.

FIG. 14 illustrates another way of attaching the system to a surface and allows the system to be outside of the mechanism of delivery and still delivering stimulation.

FIG. 15 illustrates a method of attaching a treatment system externally to pet housing products.

FIG. 16 illustrates a method of externally attaching a treatment system to products such as chairs or recliners for calming or reducing stress.

FIG. 17 illustrates separate forms of delivering the system that do not attach to other products.

### DETAILED DESCRIPTION OF THE INVENTION

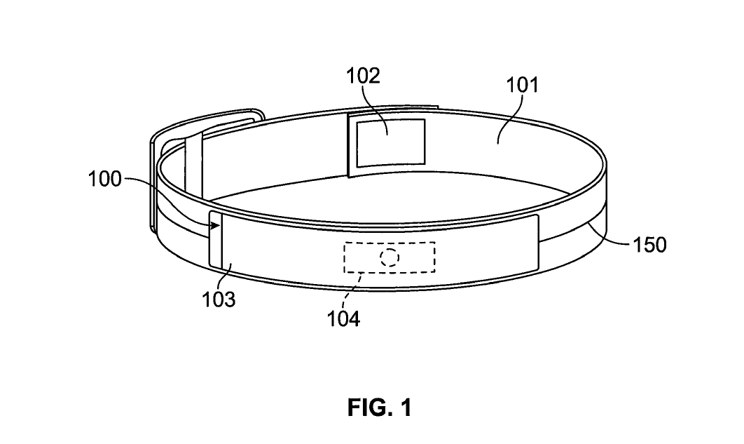

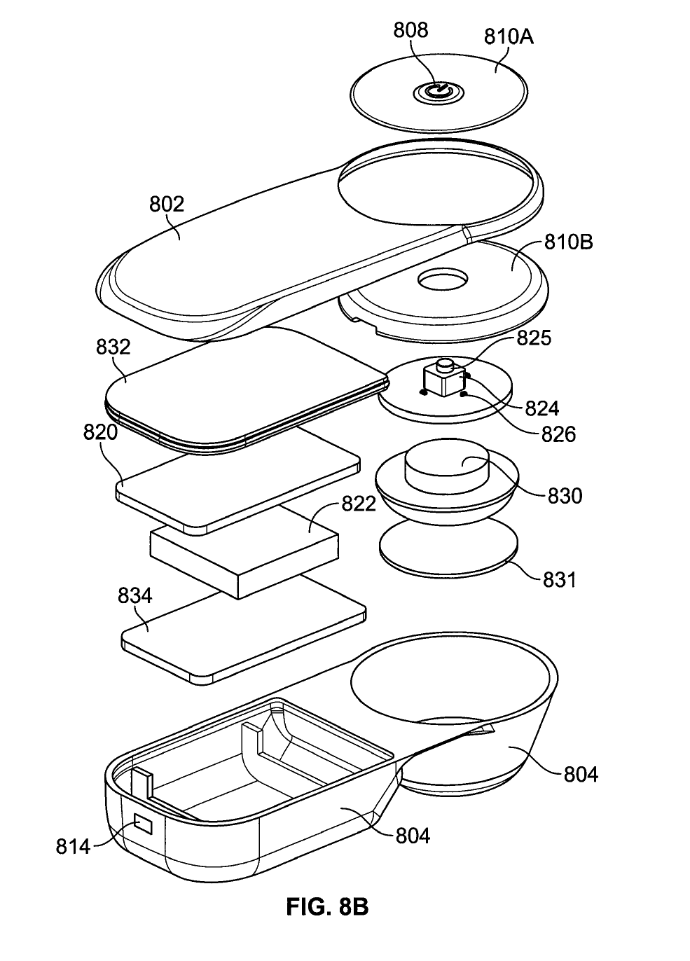

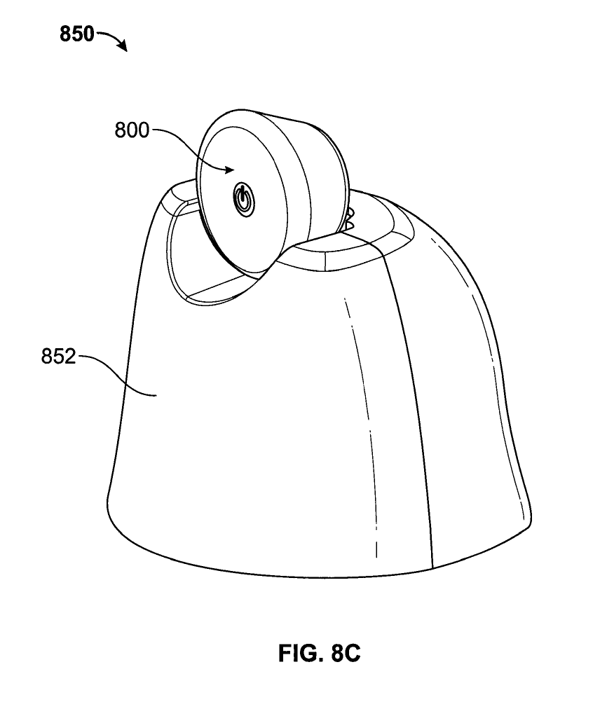

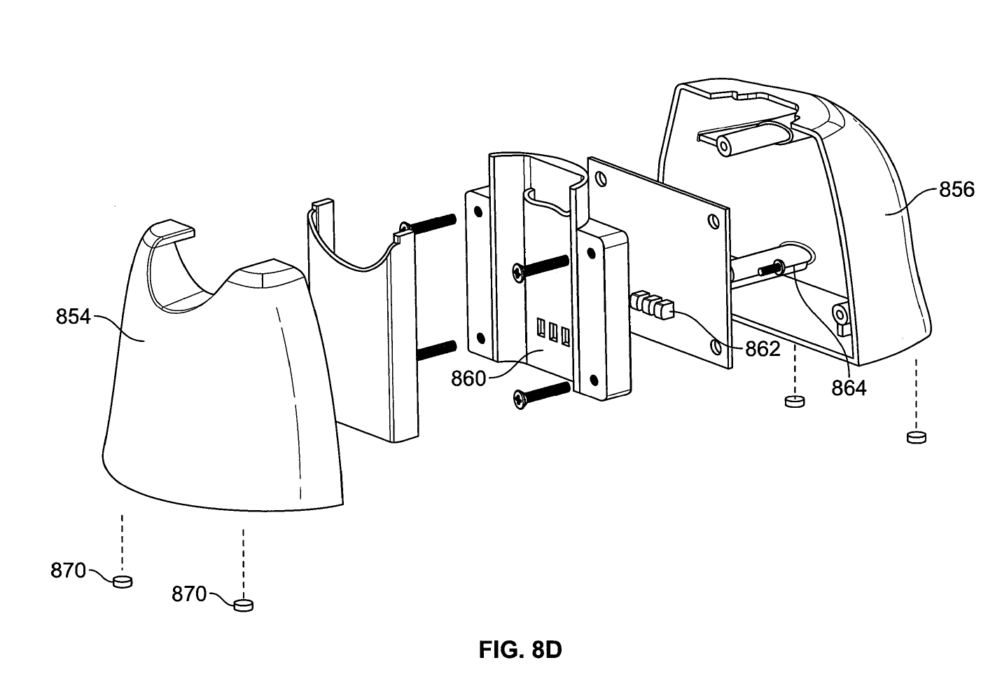

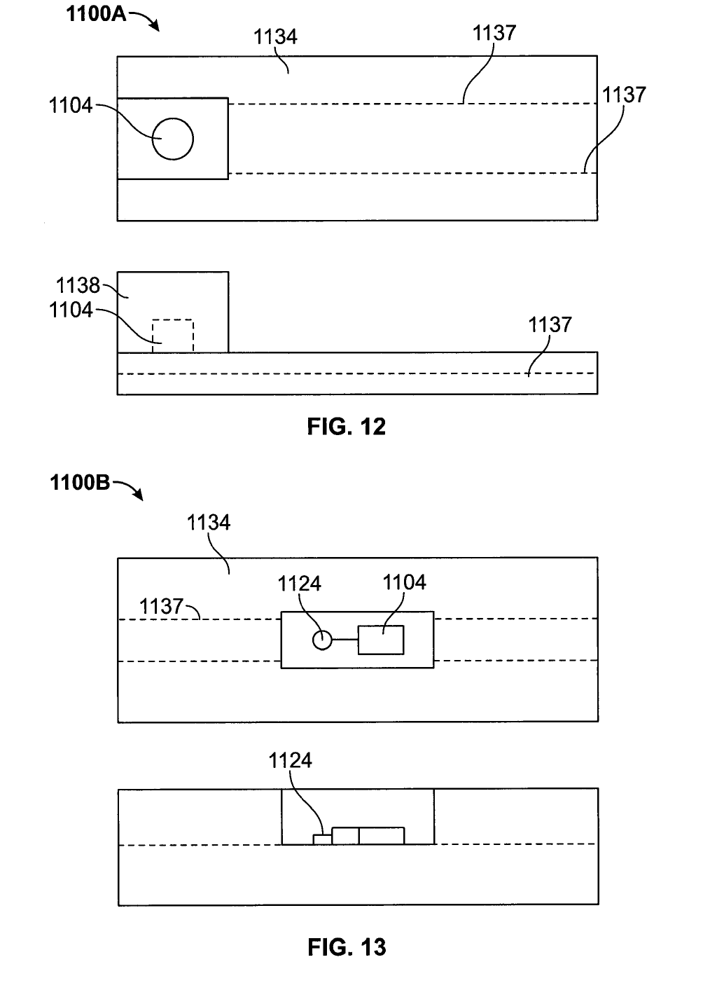

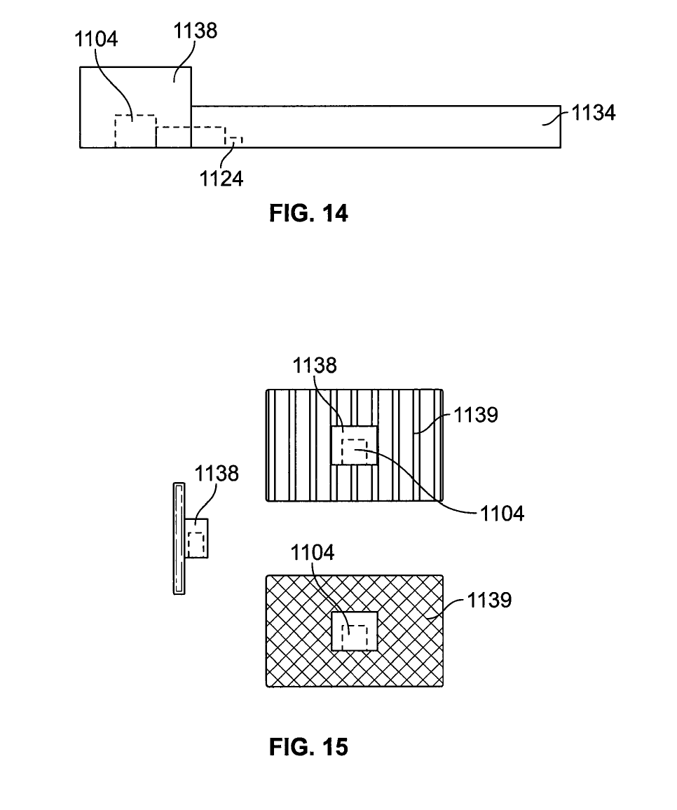

The various example embodiments disclosed herein include various methods and apparatuses to deliver non-invasive external therapeutic stimulation, specifically tones, vibration, and light, to animals and humans. Apparatuses include wearable embodiments such as animal harnesses, collars, wraps, shirts and halters, as well as human neck pillows, neck wraps and shirts. Non-wearable embodiments include pillows, plates, chair and kennel attachments, balls, toys and stuffed animals. In each apparatus, a method or device to deliver therapeutic stimulation is inserted or attached. FIGS. 1 through 7 describe wearable form factors; FIGS. 8 through 11 detail simple and easy to use delivery methods or devices; and FIGS. 12 through 17 show non-wearable form factors.

Referring now to the Figures, FIG. 1 describes an example embodiment of a therapy system 100 that includes a wearable collar or band member 101 with clasp 102 that is placed around the neck of a mammal with a pouch or pocket 103, or a base plate to attach, to hold a therapeutic delivery device 104 on top of a neck or along a spine of a mammal. Pouch 103 (or pocket or base plate) is positioned to hold therapy device 104 in place on top of the neck and along the spine so as to deliver therapeutic energy that can be heard easily through the ears, felt easily along the spine and into the brain, and perceived easily by the eyes. The additional benefit of these embodiments is to allow the simple removal of therapy device 104 to be recharged, repaired or replaced, without removing wearable member 100.

Still in more detail of FIG. 1, the construction of the collar or band or wearable member 100 includes the following: a band made from lightweight and breathable materials and fabrics so as not to be constrictive to the animal or mammal. An adjustable strap (such as 102) is placed around the neck between the head and front legs and fitted snugly to secure it in place. The adjustable strap around can be looped through a hook and secured by a hook and loop system clasp 101, buckle or similar method. A pouch or pocket 103 that has a slot or opening with a flap closure to allow easy and secure access to attach and remove device 104, such as needed to recharge, change settings, replace, or similar. A base plate (not shown) can be placed into the harness with the function being to attach and secure therapeutic delivery device 104. Extension leads 150, conductive materials or similar elements could be embedded or inserted into the harness so as to help transfer the vibrations coming from the therapeutic device and spreading throughout the harness to help deliver the therapy.

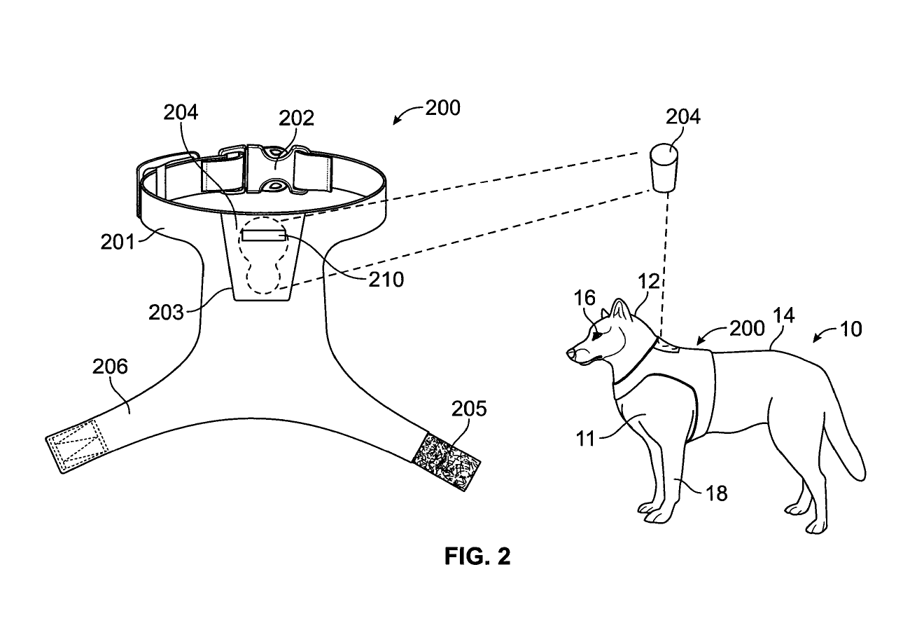

FIG. 2 in greater detail describes a wearable harness 200 with clasp 201 that is placed on an animal 10 and includes a pouch or pocket 203 to hold, or a base plate to attach, a therapeutic delivery device 204. The pouch, pocket or base plate (therapy delivery portion) 203 is positioned to hold device 204 in place on top of 12 neck and along spine 14 so as to deliver vibrational energy that can be heard easily through the ears, felt easily along the spine and into the brain, and perceived easily by 16 eyes. The additional benefit of these embodiments is to allow the simple removal of device 204 to be recharged, repaired or replaced, without removing the wearable member.

Still in more detail of FIG. 2, the construction of the harness 201 with support band member 206 includes the following: a band made from lightweight and breathable materials and fabrics so as not to be constrictive to animal 10. An adjustable strap or support member 206 is placed around an upper torso 11 and/or neck 12 behind front legs 18 and fitted snugly to secure it in place. Adjustable strap 206 around the torso can be looped through a hook and secured by a hook and loop system, clasp 205, buckle or similar method. A pouch or pocket 203 that has a slot or opening with a flap closure 210 to allow easy and secure access to attach and remove device 204, such as needed to recharge, change settings, replace, or similar. A base plate (not shown) that is placed into or onto the harness with the function being to attach and secure therapeutic delivery device 204. The extension leads, conductive materials or similar method (not shown) can be embedded or inserted into the harness so as to help transfer the vibrations coming from the therapeutic device and spreading throughout the harness to help deliver therapy. An adjustable collar 201/202 placed around the neck of the animal to help hold the pouch in position and securely on the animal. In a related embodiment, an adjustable breast strap that is attached to the underside of the collar to the underside of the torso strap and between the front legs includes a blood pressure or heart rate monitoring system that connects to and activates device 204.

In order to deliver the therapy, device 204 or similar therapeutic device, is inserted and placed securely into the slit opening of the pouch or pocket, or snapped into the base plate. Once positioned on top of the neck and spine, the device can be activated as needed so as to deliver tonal and vibrational energy for a set time. The tonal and vibrational energy is delivered at specific frequencies that activate or inhibit certain mechanisms or functions in the mammalian body.

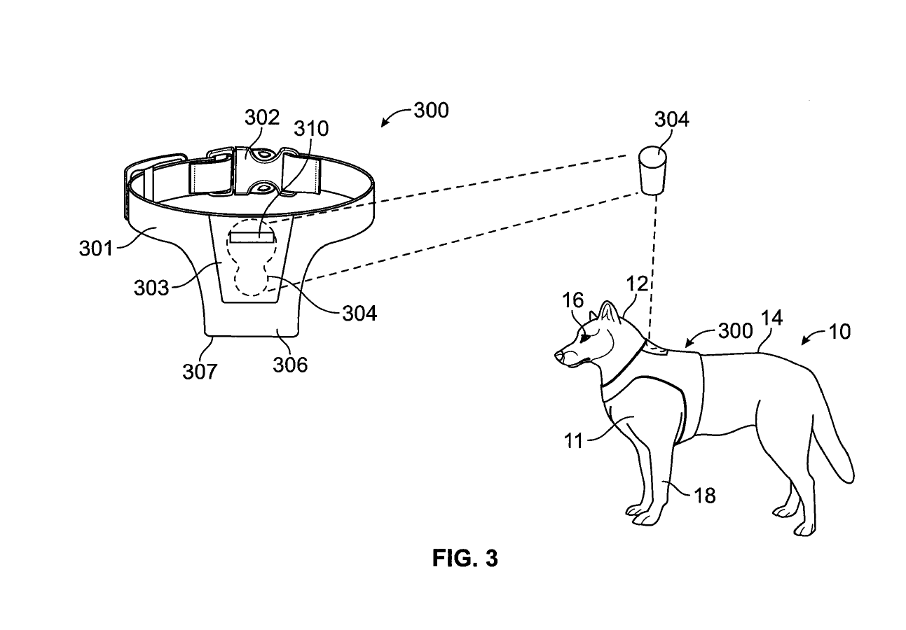

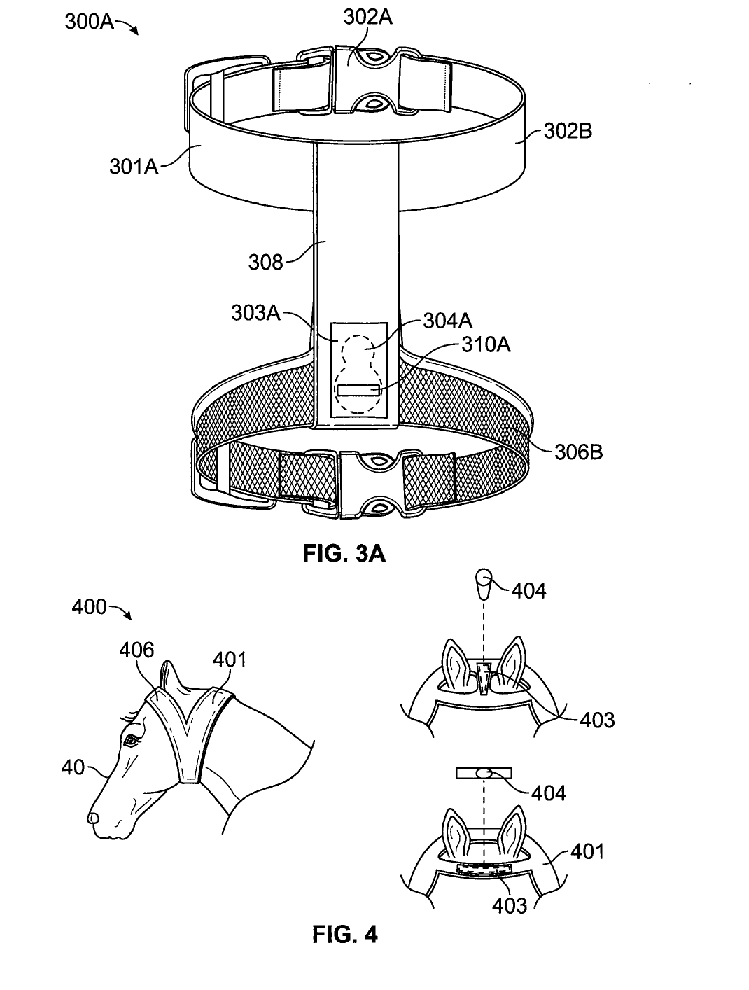

Referring now to FIGS. 3 and 3A, FIG. 3A shows a therapy system 300 that includes a wearable collar 301 that is placed and worn around neck 12 of an animal 10 that includes a pouch, pocket 303 or base plate (not shown) to hold a therapeutic delivery device 304 on top of the neck and along spine 14. The pouch, pocket or base plate extends 306 from the front of the collar near the head of the animal and back towards the rear. It may have a rigid border 307 to help hold the pouch on top of the spine and to keep it from slipping under the neck. The benefit of this design is a smaller form factor than system 200, without the need for the band around the torso.

In one example embodiment of the therapy, a therapy deliver apparatus described in system 300 was applied to seven canines that were suffering from anxiety, were administered the therapy for five minutes each by placing the collar around the neck of the animal, positioning the device on top of the spine, and activating the device. The therapy source was an audio file that played a series of tones ranging from 65 to 300 Hz through the vibration speaker that could be heard and felt by the animals. A veterinary behaviorist measured anxiety symptoms, along with heart rate readings and echograms assessments. On six out of seven dogs, a significant decrease in all measurements was recorded.

In another example embodiment of the therapy, a therapy delivery apparatus described in system 300 was applied to one dog with severe separation anxiety that obsessively licked the floor while the owner got ready to leave the house was administered the therapy for five minutes for three days in a row. Each time after device activation, the dog stopped the licking behavior and sat calmly by the owner's feet. At the end of the three day trial, the owner observed that the dog's anxiety was significantly improved, indicating that a wearable system that is used consistently would result in positive outcomes.

The construction materials and delivery of therapeutic energy are similar to those described in the other therapy systems described above. Referring now to FIG. 3A is a wearable band 301A with clasp 302A that has a pouch, pocket 303A or base plate that sits on top of the neck or spine of an animal to hold therapeutic delivery device 304A, and is placed and secured around the torso. A unique feature of this is adding the ability to connect device 304A to an existing collar via extension 308 that includes support member 306A. This benefit allows the owner to use the band for therapy in conjunction with using their existing collar 301A. The construction materials and delivery of therapeutic energy are similar as those described in earlier therapy systems above. Support member 306B is made of a mesh-like material in this example. Pocket 303A includes a flap 310A to enclose device 304A in this example.

Referring now to FIGS. 4A-4C, a therapy system 400 is shown which includes a wearable halter 401 with size adjusting material that is placed around the neck and ears of an animal such as a horse 40 or cow that includes a pouch, pocket 403 or base plate that sits between or near the ears to hold a therapeutic delivery device 404. A unique feature of this design is having the ability to keep device 404 in place near the ears and over the brain and spinal column. In FIGS. 4B and 4C, the construction materials and delivery of therapeutic energy are similar as those described in the Figures above.

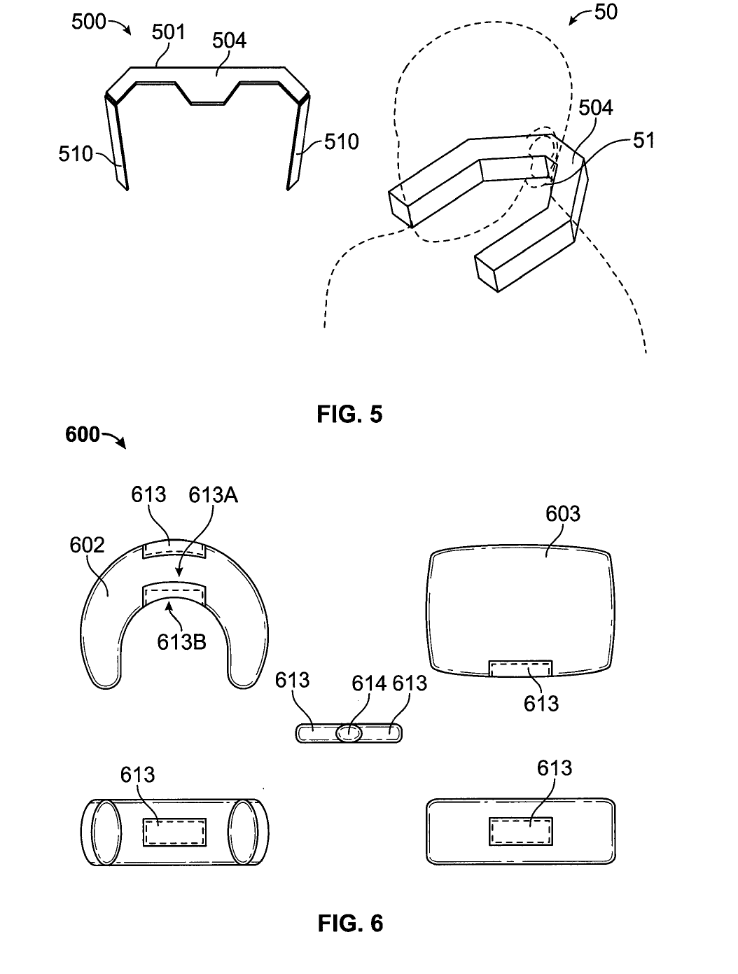

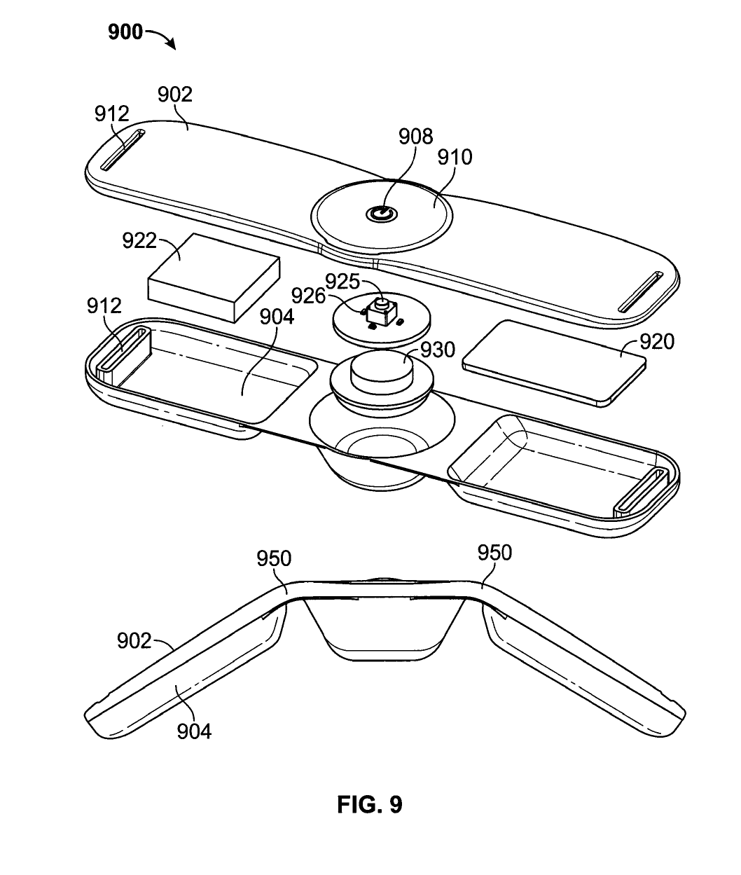

Referring now to FIG. 5, a therapy device 500 is shown that includes a wearable device 501 that is placed on and around the neck 51 of a human 50 and incorporates a therapeutic delivery device 504 such as described in more detail in FIGS. 8 and 9. In this example embodiment, device 501 has a tensile-based, retractable, foldable or similar arm extensions 501 to hold the unit 504 securely in place on the back of the neck. The arm extension (or extensions) are foldable similar to sunglasses and securely stored when not in use. Uses for this type of design 500 include anxiety, balance and stability, training, performance improvement and recovery for sports such as golf, relaxation and focus for travelers and professionals such as doctors. Construction materials for device 500 could be similar to those listed in Figures above and the delivery of therapeutic energy is similar as those described in the Figures above.

In one example embodiment, device 500 was successfully used on nine humans with balance and stability issues, along with reduced kinesthetic strength and elevated blood pressure, were given the therapeutic device to wear around the neck for five minutes. On each human, balance, stability, blood pressure and kinesthetic strength were improved by delivering vibrational and tonal energy in the ranges of 45 through 250 Hz. Additionally, two of these patients suffered from shoulder and knee pain. After the therapy was administered, both patients indicated that their level of pain had been reduced dramatically.

Referring now to FIG. 6, there are illustrated top and bottom views of other therapy systems 600 including both wearable 602 pillows and non-wearable 603 pillows that include a pouch or pocket 613 to hold a therapeutic delivery device 614. Pillow 602 can be placed and worn on the neck of an individual while traveling, sitting in chairs, or resting. Pillow 604 can be used while lying down, sleeping, resting in a seated position, or similar.

Referring again to FIG. 6, pouch or pocket 613 to hold delivery device 614 can be placed in the front pouch 613B, closer to the wearer, or in the rear pouch 613A, to allow for easier access. The pouch or pocket can be accessed and secured in place by a foldable lining, a zipper, buttons, or similar method.

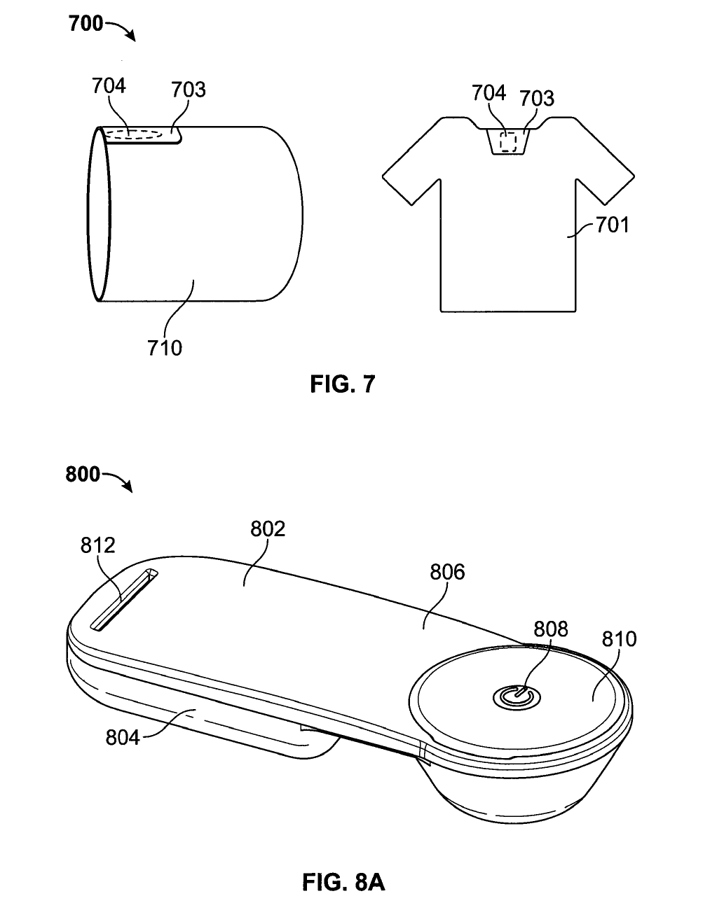

Referring now to FIG. 7, there is shown therapy delivery system 700 that includes a wearable shirt 701 and an animal wrap or shirt 710, both for animals and humans that include a pouch or pocket 703 to hold a therapeutic delivery device 704 on the back of the neck and along the spine of the subject. Animal shirt or torso wrap 710 is placed on an animal with the pouch pocket 703 (or base plate) sitting along a spine, near the upper torso and neck region of the subject. Construction materials are similar to previous descriptions and Figures listed herein. Shirt 701 for humans can be worn with a pouch or pocket 703 on the back, on the upper torso, and potentially included in the neck collar. Construction materials, manufacturing methods and fabrics are similar to known shirts, and to those listed herein.

Referring now to FIGS. 8A-8D, FIG. 8A shows a therapeutic delivery device 800 that can be inserted into or attached to the therapy delivery systems described herein, or used by itself In this example embodiment, unit 800 includes a housing 802 comprised of a rigid bottom plate 804, flexible top overlay 806, a controller push button 808, lighted top display 810, an opening 812 to attach or hold automatic or wireless controls. Unit 800 also includes a port 814 (not shown) near opening 812 to be used as a data and communication port. The benefits of this design are a short form factor, flexible mid-plate and lightweight so as to be easily worn.

Referring now to FIG. 8B, there is shown the internal components to FIG. 8A that may include a programmable control board 820 that includes energy generating sources such as audio files, a power source such as a battery 822, micro switch 824 with support plate 826, wireless connectivity operation 832, accelerometer or other monitoring device 834, and a vibration speaker or transducer device or therapy output device 830, LED light source 825 or similar method to output therapeutic vibrational energy. The unit can also include functionalities such as an accelerometer, wireless connectivity, and vitals monitoring capabilities. A therapy output device support plate 831 and a control button cover 810B is also included.

Referring further to FIGS. 8C and 8D, there is shown a therapy device and charger system 850 that includes therapy unit 800 and charging station 852 and/or communication portal for device 800 described in FIG. 8A. One benefit of incorporating such a station into the system is to move charging mechanisms off of the device and onto the base unit, thus decreasing the weight and size of the wearable device. Charging station 852 includes a front 854 and back cover 856, a receptor plate 860 with ridges to hold device 800, power recharging board 862 and communication ports 864 to access device 800. Optimal hose plugs 870 prevent slipping of station 852.

Referring now to FIG. 9, there is shown exploded and side views of therapy unit 900 of a different form factor of a therapeutic delivery device 900 described in FIGS. 8A and 8B. The internal components and product features are similar and include a housing comprised of a top cover 902, a bottom pliable bottom 904, a control button 908 and cover 910, attachment opening 912, control board 928, micro switch 924, LED 925, switch support plate 926 and a therapy output device 930, such as a speaker or transducer. The benefits of this design are a lower height form factor as the components are distributed, and a longer form factor for additional therapeutic touch points to the mammalian recipient with a bendable portion 950 to accommodate mammal form.

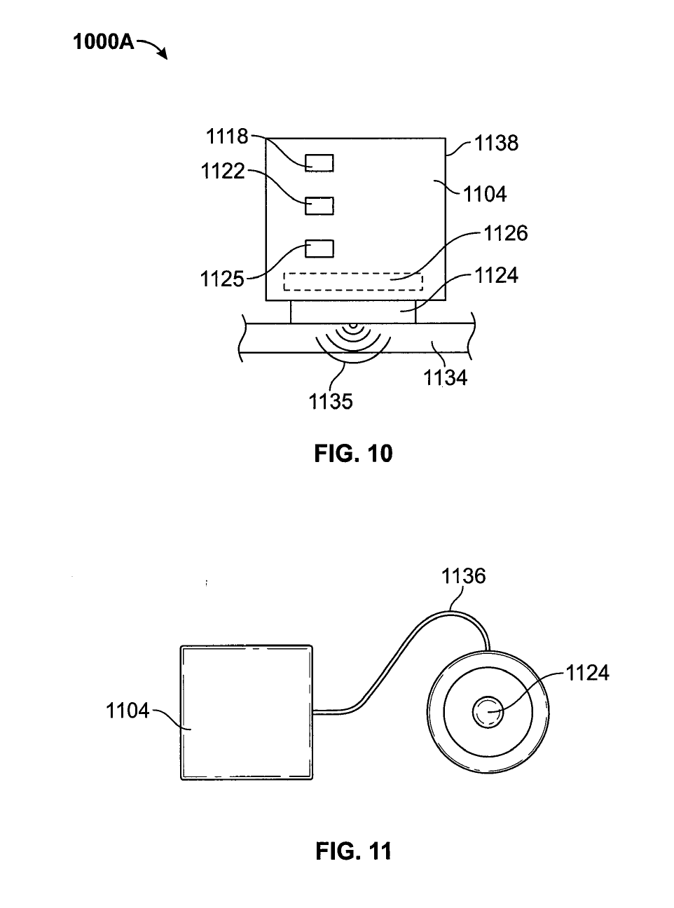

Referring now to FIGS. 10 and 11, there are shown non-wearable, external, stimulation devices, 1000A and 1000B respectively, to deliver vibration, tones and audio to humans and animals for therapeutic purposes. These devices have a power mechanism, volume, and intensity controls, a power source, a rechargeable outlet, and a mechanism to store data or stimulation methods on the device. This data can be in many forms such as tones, music, and the like. This device can be used as pictured, as a stand-alone product, as whole inside other delivery products such as below, and also broken into components and used in different forms. Also described are ways to remotely or wirelessly control and interact with the system, such as simple handheld devices, keypads, touch screen, or similar devices. These devices can be in many shapes and forms, and the components detailed below can be used separately without the specifically described structures.

In various example embodiments, included with the devices are components such as a:
Power button 1118—to turn the control panel on or off
Vibration or other similar speaker 1124 to deliver vibrations, tones or audio into humans or animals for therapeutic benefits by way of or through a plate 1134 (rigid or pliable)
Data port 1125, hard drive, or other similar method to store and deliver
Battery 1126 or other device for storing power to operate the device
Within a housing 1138
Electronics operating board for controlling the device (not shown)
Volume controls 1122
Indicator lights—showing which stimulation method is selected or active
Plug-in—for external power or audio loading (or data loading) 1125
Remote control to operate device without having to manually touch (via cable 1136 in FIG. 11)
Wireless port—to remotely connect to device

Still referring to FIGS. 10 and 11, when the user turns on the device, consistent energy in the form of vibration, tones or other frequency energy is delivered through vibration speaker 1124 and into an attached surface or plate 1134. Here, the human or animal will interact, hear or feel the vibrational energy for health benefits for a set period of time. The user can manually turn off the device or it will turn off automatically after a set period.

The vibration, tones or audio functions will be available in multiple levels that can be controlled via the mode button and stored on the disk drive. The wireless port allows the user to control the unit from a remote location, via a handheld, remote, or other similar communication method a Wi-Fi system connected to the Internet. The materials and surfaces described below that the system attaches to or is included into, may have leads, specific materials or other transmittal components embedded into it to deliver stimulation more consistently through the products. The construction details of the invention in FIGS. 10 and 11 include the system being made from metal, plastic, ceramic, glass (hardened) or other casing material.

Referring now to FIGS. 12, 13 and 14, (like components from FIGS. 10 and 11 are used) are top and side views of other therapy systems 1100A and 1100B of delivering external therapeutic stimulation by attaching the system to pliable and rigid surfaces 1134 made from materials such as wood, metal, plastic, ceramic, thick glass or other similar hard surface. The various systems can be attached directly to surface, inside an enclosure 1138 via speaker 1124 that is on top, embedded inside, or on the side of the delivery surface or plate. In a related embodiment, electrodes or leads 1137 are included to help deliver therapy. A main benefit of this method is to allow for secure, safe and reliable ways of delivering the stimulation over a larger surface for uses such as next to, or included into, products such as pillows, mattresses, beds, crates or other similar surfaces. These can help calm, heal, decrease pain, or have other beneficial uses.

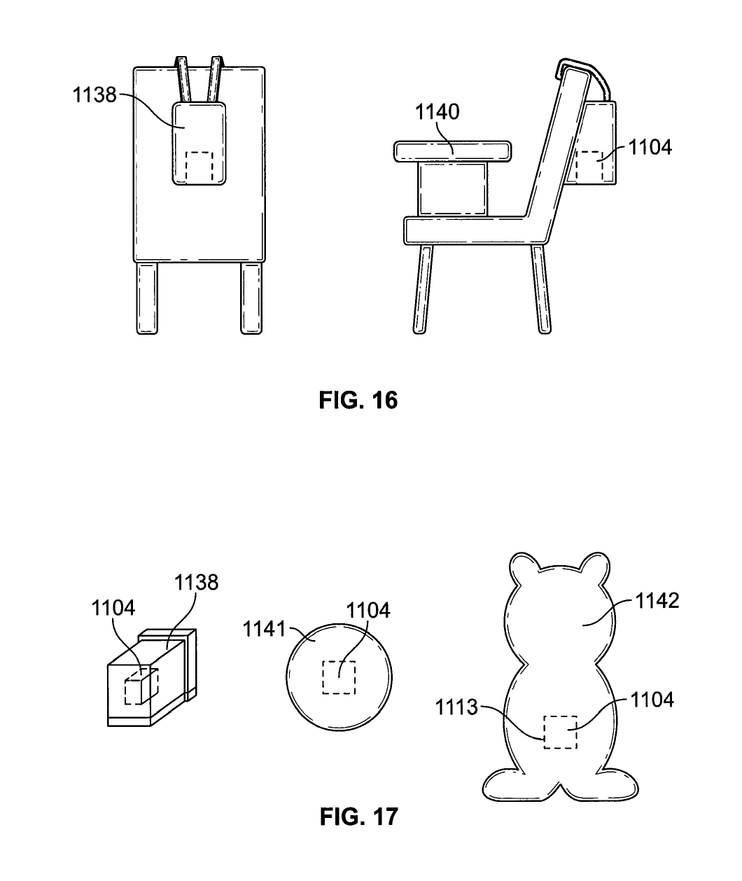

Referring now to FIGS. 15 and 16, are described other methods and form factors of attaching the therapy systems, such as 1138, disclosed herein, safely, securely and therapeutically to surfaces, enclosures, such as crates 1139, kennels, chairs 1140, or other fixed surface where animals or humans sit 1140, lie down or spend time. Benefits here include simple ways of delivering stimulation to help calm, heal, decrease pain, or other similar uses, in various attachment formats.

Referring now to FIG. 17, shown therein are methods of delivering the system in an enclosed box format 1104, for uses such as on a tabletop or other hard surfaces, and in formats such as a ball 1141 or other shape such as a toy or stuffed animal 1142, for uses inside kennels, crates, or other similar enclosures. Health benefits are similar to above descriptions. Additional benefits include: 1) safety issues as protection from falling, chewing, etc.; 2) mobility to take and use any places; and 3) security from dust and other harmful effects over just using the system as a standalone device.

The following U.S. patents and publications are herein incorporated by reference in their entirety: U.S. Pat. Nos. 5,101,810; 5,178,134; 5,314,403; 5,895,348; 6,024,407; 6,193,677; 6,615,197; 7,445,607; 7,981,064; 8,077,884; and 8,079,968.

Other known vibrational systems include: the X-Vibe Vibration Sound System (www.innovationx.tv) and the Smart Vest and VibraMax Systems by Nexneuro (www.nexneuro.com), but these fail to provide the form factor and simplicity provided by the various embodiments described herein.

This written description of the invention enables one of ordinary skill to make and use what is presently described. A person of ordinary skill should understand and appreciate that there are variations and combinations to the methods described herein, and should therefore not limit the invention to what is described, but by all the embodiments and methods within the scope and spirit of the invention.

1. A system for providing a therapeutic treatment to a mammal for a selected mammalian condition comprising.
a wearable member configured for use about an upper torso of a mammal; and
an energy module configured to generate energy waves in an energy range particularly configured to provide a stimulation that is a therapeutically effective treatment for the selected mammalian condition, said energy module adapted to be supported by said wearable member about the upper torso of the mammal,
wherein said wearable member includes a therapy delivery portion configured to position said energy module at a treatment site about the upper torso.

2. The system of claim 1 wherein said therapy delivery portion of the wearable member is comprised of a pocket or pouch element adapted to support and position the energy module about the treatment site.

3. The system of claim 1 wherein said therapy delivery portion of the wearable member is comprised of an attachment device for securing the energy module, the attachment device being selected from the group consisting of a hook and loop patch, a loop or ring, and a button and snap button.

4. The system of claim 1 wherein the wearable member is comprised of a size adjusting material.

5. The system of claim 1 wherein the wearable member includes a support band member adapted to further secure the wearable member about the upper torso of the mammal.

6. The system of claim 5 wherein the support band member includes a means for adjusting the support band member about a torso of the mammal.

7. The system of claim 1 wherein the wearable member includes at least one flexible member configured to bend about the torso of the mammal.

8. The system of claim 1 wherein an energy type for the energy waves is selected from a group consisting of radio waves, low power light waves, low power infrared waves, ultrasonic waves, audio and mechanical waves.

9. The system of claim 1 wherein a predetermined time and an energy level within the energy range are functions of a desired treatment for the selected mammalian condition.

10. An apparatus for delivering therapeutic energy to at least a portion of a mammal for a selected mammalian condition comprising:
a therapy output device adapted to generate energy waves in an energy range configured to provide a therapeutic effect on a mammal;
means for controlling said therapy output device, said controlling means including an amplifier, memory, and an audio file playing module;
a power supply means operationally coupled to said controlling means and said therapy output device; and
a housing configured to enclose said therapy output device, controlling means and power supply means.

11. The apparatus of claim 10 further including a power control assembly operationally coupled to said controlling means, said power control assembly including a microswitch and at least one LED.

12. The apparatus of claim 10 wherein said housing is configured to include port means for managing data and external energy charging input.

13. The apparatus of claim 11 wherein the housing is configured to support the therapy output device between a pair of outer opposing portions of the housing.

14. The apparatus of claim 10 wherein an energy type for the energy waves is selected from a group consisting of radio waves, low power light waves, low power infrared waves, ultrasonic waves, audio and mechanical waves.

15. A system according to claim 10 further including a charging unit configured to hold the therapeutic delivering apparatus.

16. A system for providing a therapeutic treatment to a mammal for a selected mammalian condition comprising:
an energy module adapted to generate energy waves in an energy range configured to provide a therapeutic effect on a mammal; and
means for delivering the energy waves from the energy module to a treatment site, said energy delivering means being coupled to said energy module, wherein said energy delivering means is configured to direct the energy waves proximate to the treatment site of the mammal.

17. The system according to claim 16, wherein said energy delivering means is comprised of a plate member adapted to be in contact with a speaker device that forms part of the energy module.

18. The system according to claim 16 wherein said energy delivering means is comprised of a speaker device remotely coupled to said energy module, said speaker device adapted to deliver energy waves to the mammal.

19. The system according to claim 16, wherein said energy delivering means is comprised of a housing member adapted to be in contact with a speaker device that forms part of the energy module, the housing member configured to have at least one lateral protruding member adapted to deliver energy waves proximate to the mammal treatment site.

20. The system according to claim 18 further including means for remotely and wirelessly communicating with the energy module, wherein said energy module is configured to be responsive to said communication means such that a treatment is delivered to the mammal for a predetermined time.
